(19) United States
(12) Patent Application Publication
(10) Pub. No.: US 2011/0088382 A1
(43) Pub. Date: Apr. 21, 2011

(54) DEVICE AND METHOD FOR CONVERTING WIND ENERGY

(75) Inventors: Rikard Berthilsson, Furulund (SE); Mats Alakuela, Lund (SE)

(73) Assignee: WINFOOR AB

(21) Appl. No.: 12/737,221

(22) PCT Filed: Apr. 3, 2009
(86) PCT No.: PCT/SE2009/050351

§ 371 Date: Dec. 20, 2010

(30) Foreign Application Priority Data
Jul. 4, 2008 (SE) 0801598-4

(51) Int. Cl. F15B 13/00; F04B 17/02; F03D 5/06; F03D 7/00; F03D 11/00

(52) U.S. Cl. 60/398; 417/334; 416/1; 416/41; 416/81; 416/80

(57) ABSTRACT

A device for converting wind energy into a reciprocating motion. The device has a sail that extends in a main wind direction and pivotally oscillates when subjected to wind. The sail is connected to a first support that is configured to move in a first direction when the sail during its oscillation moves towards any of two outermost positions from a neutral position, and move in a second direction opposite the first direction when the sail during its oscillation moves towards its neutral position from any of its outermost positions, thereby creating a reciprocating motion of the first support when the sail is subjected to the wind. A further device, a method and a system are also described.

### FIELD OF INVENTION

The present invention relates to a device, system and method for converting kinetic energy in wind into useful work.

### BACKGROUND ART

It is of vital importance to improve our current solutions for producing energy. Fossil fuels like oil, coal and natural gas are limited and need to be replaced in the future. Fossil fuels are also creating problems related to its emission of carbon dioxide and several toxic gases. An attracting alternative is given by renewable energy sources that do not suffer from the problems we face with fossil fuels. However, an important problem is that these energy sources are often considerable less cost efficient than traditional energy sources.

One of the more successful examples of renewable energy sources comes from wind energy, where we today have an established industry. The wind offers a nearly unlimited source of energy. Furthermore, a wind turbine or apparatus has nearly no negative effects on the environment, when it is in operation.

In the literature several technologies have been proposed for wind energy apparatuses.

One method and apparatus for wind power is disclosed in U.S. Pat. No. 4,915,584, which document describes a wind turbine that is based on using a horizontal oscillation blade or wing. The wing is stiff and allowed to rotate around an axis a fraction of a full circle and then to rotate back again. The method requires an oscillating movement to be converted into a circular movement.

This is also the case for the method described in FR-510 435. Another similar method based on using a blade is disclosed in U.S. Pat. No. 3,995,972.

Another method and apparatus is presented in U.S. Pat. No. 4,486,145, in which document the apparatus performs an oscillating movement partially around a vertical axis when subjected to wind. This apparatus suffers from being mechanically complicated which is likely to cause problems.

Further background art is described in GB-202 74 94 A and in WO-2006/043600 A1.

However, the cost of producing energy with the above described technologies is expected to be at least as high as for standard, propeller based wind turbines. As a result, the production price of electricity from wind energy can currently not successfully compete with traditional resources such as fossil fuels, nuclear energy and hydropower.

### SUMMARY OF THE INVENTION

It is an object of the present invention to provide an improvement of the above techniques and prior art.

A particular object is to provide a cost-efficient way of converting wind energy into another energy form, such as into electricity or a movement of an object.

These and other objects as well as advantages that will be apparent from the following description of the present invention are achieved by devices, a system and a method according to the respective independent claims. Preferred embodiments are defined in the dependent claims.

Hence a device is provided for converting wind energy into a reciprocating motion, said device comprising a sail connected to a first support and connected to a second support arranged at a distance from the first support, so that the sail is capable of pivotally oscillate about a geometrical axis extending between the supports. The sail is configured to, when subjected to the wind, extend in a main wind direction, which defines a neutral position of the sail, and to pivotally oscillate about the axis and between two outermost positions at a respective side of the neutral position. The first support is configured to move in a first direction when the sail during its oscillation moves towards any of its outermost positions from its neutral position, and move in a second direction opposite the first direction when the sail during its oscillation moves towards its neutral position from any of its outermost positions. This creates a reciprocating motion of the first support when the sail is subjected to the wind.

The inventive device provides an oscillating movement of a wind element that arises naturally and requires no complicated mechanics for changing between backwards and forwards motion, i.e. the motion between the outermost positions via the neutral position, thus offering a robust and reliable solution. The efficiency of converting the wind's energy to useful work is high and the cost of production is relatively low.

In other words, it may be said that the sail is arranged vertically and is attached to a supporting structure at its top and/or bottom. As the sail is subjected to wind it starts to oscillate sideways perpendicularly to the direction of the wind. This is a known phenomenon similar to a flag waving in the wind. The movement of the sail changes the angle between sail and the direction of the wind in a periodic manner which induces a force on the sail along the direction of the wind. In this context, the wind has a general direction which is horizontal along a ground surface on which the device is arranged. The force depends among other things on the angle between the sail and the direction of the wind, the shape of the sail and its surface properties.

The cost of the inventive device is low compared to conventional rotor blades. Moreover, it captures the wind efficiently, it has low weight and it can be scaled to large size structures. Furthermore, the mechanical movement of machine parts in the construction is rather small, with relatively low speed compared to large size conventional rotor blades where the tip of the rotor may have a very high speed causing problems with stability. It should be noted that “pivotally oscillate about a geometrical axis” means that the sail is moving about the axis in a quite regular manner, which is in sharp contrast to the irregular flattering (flapping) of a sail in a more flag-like arrangement.

The inventive device may further comprise a resilient member that biases the first support in the second direction.

The resilient member may be configured such that, when the sail is subjected to a specific wind speed, a force exerted by the resilient member on the first support in the second direction is smaller than a force exerted by the sail on the first support in the first direction when the sail is in any of its outermost positions, and such that a force exerted by the resilient member on the first support in the second direction is greater than a force exerted by the sail on the first support in the first direction when the sail is in its neutral position.

The sail may be made of fabric. The sail may also be made of a composite material like fiberglass or carbon fiber.

The sail may have greater stiffness in a direction parallel with the main wind direction when the sail is subjected to wind, in comparison with the stiffness of the sail in the direction transverse the main wind direction.

The sail may comprise ribbons extending in the main wind direction when the sail is subjected to wind, and the sail may comprises ribbons extending in the sail in a direction from an upper to a lower part of the sail, i.e. in a substantially vertical direction.

Typically, the ribbons may be made a stiff material like a steel wire or steel ribbon, or they may be made of any other elongated structure with a stiffening profile of a suitable strengthening material such as a composite material like fiberglass or carbon fiber.

The sail may also be configured to be self-supportive in a vertical direction, which means that the sail does not hang down in a vertical direction even if wind conditions are poor. This may also be expressed as a sail which “does not hang like a conventional flag” when no wind is present. The above mentioned ribbons are examples of means that provide a self supportive sail.

The area density of the sail may increase in a direction parallel with the main wind direction when the sail is subjected to wind. The sail may also comprise one or several weight elements. Preferably such weight elements are arranged at a rear part of the sail.

The sail may have a peripheral edge extending substantially along said geometrical axis. Optionally the sail extends on both sides of the geometrical axis.

The peripheral edge of the sail may comprise a wire attached to the first and second support, which may be a steel wire, a rope or any or a wire made of a suitable fiber material.

The sail may be configured such that the movement of the sail between the outermost positions via the neutral position forms an arc.

The sail may be configured such that, when the sail is in any of its outermost positions, the shape of the sail forms an arc bending in a direction away from the neutral position of the sail.

The sail may be configured to oscillate freely between the two outermost positions. In brief, this generally means that there is no connection element that may prevent the oscillating movement and that is connected to the sail at a point from a center of the sail (as seen in the wind-direction) to the rear of the sail (the most distant part of the sail in the direction of the wind). Of course, this does not exclude that e.g. a rope may be connected at the rear of the sail for preventing the sail form moving past any outermost position, since such a connection does not prevent the free oscillation.

In any case, “oscillate freely” means that no connection element used to extract wind energy is connected to the sail at a point from the horizontal center of the sail to the rear of the sail.

The first support and the second support may be connected to a third support that is rotatable about a substantially vertical axis.

Each of the first support and the second support may be arranged such that they are rotatable about a substantially vertical axis.

The first support may be configured such that first direction is substantially parallel with the main wind direction.

The inventive device may further comprise a generator connected to the first support, for converting the reciprocating motion of the first support to electrical energy.

The inventive device may further comprise a hydraulic pump connected to the first support for converting the reciprocating motion of the first support to a flowing stream of fluid.

According to another aspect of the invention, a wind energy system is provided, comprising at least two of the devices described above which devices in turn each comprises the hydraulic pump. The system further comprises a fluid line connected to each hydraulic pump and to a hydraulic engine, so that each stream of fluid flowing from the hydraulic pumps are transported to the hydraulic engine.

By assembling two devices next to each other, a system is achieved which may produce more energy than what is possible with a standard wind turbine of the same height. Moreover, only one generator is needed even though several sails are employed.

The fluid line of the system may be a closed system configured to return fluid from the hydraulic engine to each hydraulic pump.

According to yet another aspect of the invention, a further device for converting wind energy into reciprocating motion is provided, said device comprising a sail connected to a first support and connected to a second support arranged at a distance from the first support, the sail being configured to, when subjected to a wind, pivotally oscillate about a geometrical axis extending between the supports. The sail, when subjected to the wind, extends in a main wind direction, and the first support is movably arranged and guided by a guide member so that the first support is allowed to at least horizontally reciprocate in said main wind direction when the sail is subjected to the wind.

Of course, the inventive devices may share corresponding features and embodiments, which means that features described in connection with the first mentioned inventive device may be incorporated in the second inventive device.

According to a further aspect of the invention, a method of converting wind energy into a reciprocating motion is provided, the method comprising

connecting a sail to a first support and to a second support arranged at a distance from the first support, such that the sail is capable of pivotally oscillate about a geometrical axis extending between the supports,

providing for the surface of the sail to extend, when subjected to the wind, in a main wind direction, which defines a neutral position of the sail,

allowing the sail to, when subjected to the wind, pivotally oscillate about the axis and between two outermost positions at a respective side of the neutral position, and

allowing the first support to move in a first direction when the sail during its oscillation moves towards any of its outermost positions from its neutral position, and move in a second direction opposite the first direction when the sail during its oscillation moves towards its neutral position, for creating a reciprocating motion of the first support when the sail is subjected to the wind.

The method according to the invention has the same advantages as the devices and system according to the invention, and may comprise any of the embodiments and features described above.

### BRIEF DESCRIPTION OF THE DRAWINGS

Embodiments of the present invention will now be described, by way of example, with reference to the accompanying schematic drawings, in which

FIG. 1 is a perspective view of the inventive device,

FIG. 2 is a top view showing how the sail pivotally oscillate,

FIG. 3 is a partial view of the sail and the first movable support,

FIG. 4 is front view of a structure that supports four sails,

FIG. 5 is a partial top view of the structure of FIG. 4,

FIG. 6 is a schematic view of a hydraulic wind energy system, and

FIG. 7 is a partial view of an embodiment of the sail.

### DETAILED DESCRIPTION OF PREFERRED EMBODIMENTS OF THE INVENTION

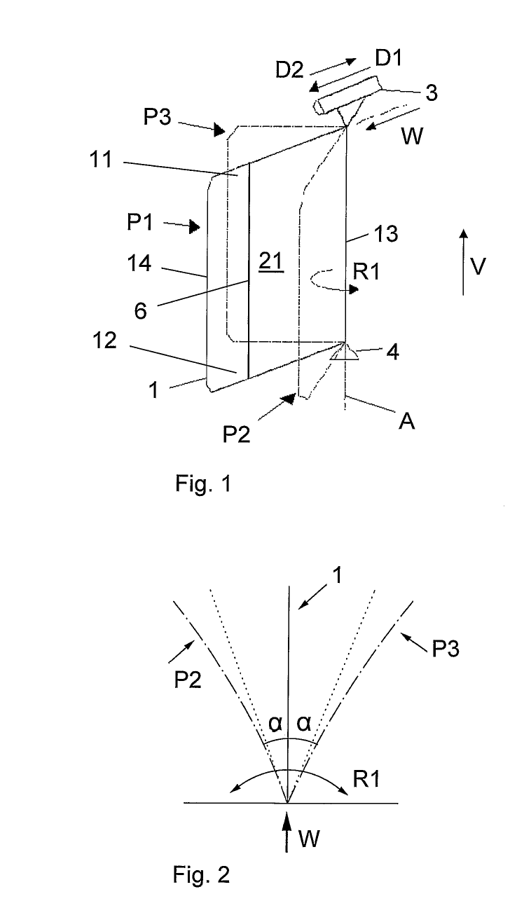

With reference to FIG. 1, a sail 1 which is made of fabric is vertically arranged and is attached at its top and bottom to a first, upper support 3 and to a second, lower support 4, so that the sail 1 is moveable at least in a direction substantially parallel to a wind direction W. The sail 1 is attached to the supporting structures 3, 4 such as to allow the sail 1 to rotate, which rotation is indicated by the arrow R1, around a geometrical axis A that extends between the sails attachment points to the supporting structures 3, 4.

The sail 1 has a front part 13 and a rear part 14 where the rear part 14 is further away in the wind direction W. The sail 1 has also an upper part 11 and a lower part 12 were the lower part 12 is, in comparison to the upper part 11, closer to the ground in a vertical direction V. A ribbon 6 extends from the upper part 11 to the lower part 12 of the sail 1. The ribbon 6 may extend the full height of the sail 1 or only a part of the height. The ribbon 6 may be arranged parallel with or inclined to the vertical direction V, and may be straight or be arranged with a curvature.

The sail 1 is self-supportive in the vertical direction V, which means that the sail 1 extends along a vertically oriented plane when the sail 1 is not subjected to any wind. Of course, this plane may be curved but the wind capturing part of the sail should for best effect preferably be stiff enough to prevent formation of any bend or fold with an angle of more than 45°, i.e. the sail 1 may not fold like a conventional flag does in calm conditions. The ribbons 6 provide the self-support and/or the sail 1 may be made of a composite material like fiberglass or carbon fiber providing a sufficient stiffness (self-support) of the sail 1.

Preferably, the sail 1 has a peripheral edge 22 that extends along the axis A, and a wire 23 at the peripheral edge, which wire 23 is attached to the first 3 and second 4 support.

Optionally, the peripheral edge of the sail 1 is offset from the axis A in a direction opposite the wind direction W. In this case the sail 1 extends in two directions, i.e. in the wind direction and towards the wind direction, which means that the axis A extends from the first support 3, through the sail 1 and to the second support 4.

The rotation R1 is limited to only a fraction of a full circle. This is to ensure that the sail 1 will oscillate in the wind but prevent it from rotating around the attachment points, or around the first and second supports 3, 4. Hence, the sail 1 oscillates back and forth between two outermost positions P2, P3 via a neutral position P1, which neutral position P1 is the position the sail 1 has when it extends in the wind direction W. The sail 1 is made of any suitable fabric-like material that allows the sail 1 to extend in the wind direction when the average wind speed exceeds a specific value, e.g. 3 m/s.

Preferably, the sail 1 is non stiff around the direction of a horizontal axis, which is parallel with the wind direction W, but stiff around the direction of a vertical axis. This is to ensure good and stable oscillating movement of the sail 1 that will efficiently capture the wind's energy. In this context, “horizontal” and “vertical” refers to a ground level plan.

The first support 3 is movable in a first direction D1 and in a second direction D2 that is opposite the first direction D1. The first support 4 is connected to a further structure, which is described in more detail below, that orients the first structure 3 so that the direction D1 is parallel with the wind direction W. A resilient member, which will be explained in detail below, biases the first support 3 in the second direction D2 that is opposite both the first direction D1 and the wind direction W, i.e. a force induced by the resilient member acts on the first support 3 for moving the first support 3 in the second direction D2.

As the sail 1 starts to oscillate perpendicularly to the direction W of the wind it also becomes subjected to a force along the wind's direction W. With further reference to FIG. 2, this force depends among other things on the angle α between the sail 1 and the direction of the wind W, the shape of the sail 1 and its surface properties. The force acting on the sail 1 by the wind increases as the sail 1 approaches any of its outermost positions P2, P3, and has is biggest value in the outermost positions P2, P3. When the sail is in its neutral position P1 with its surface 21 parallel with the wind direction W, the force from the wind acting on the sail 1 has its smallest value. This means that when the sail 1 swings or oscillates between the outermost positions P2, P3, around the vertical axis A, an oscillating force is obtained along the direction W of the wind. Of course, the force induced by the wind also depends on the wind speed.

Since the sail 1 is connected to the first support 3, the sail 1 induces a force on the first support 3 in the first direction D1. The resilient member is configured such that the force induced on the first support 3 by the resilient member is greater than the force induced by the sail 1 when the sail 1 is in its neutral position P1 and when the wind speed is above a specific value.

As a result, the first support 3 reciprocates, i.e. repeatedly moves in the first direction D1 and in the second direction D2, as the oscillating force obtained along the direction W acts on the first support 3 and when the wind speed is above the specific value. Typically a specific wind speed is about 3-5 m/s and a suitable resilient element is empirically selected for a certain type of sail.

It should be noted that the sail 1 is not completely stiff around the direction of the vertical which results in a small curvature of the sail 1 when it is in an outermost position P2 or P3, as indicated in FIG. 2.

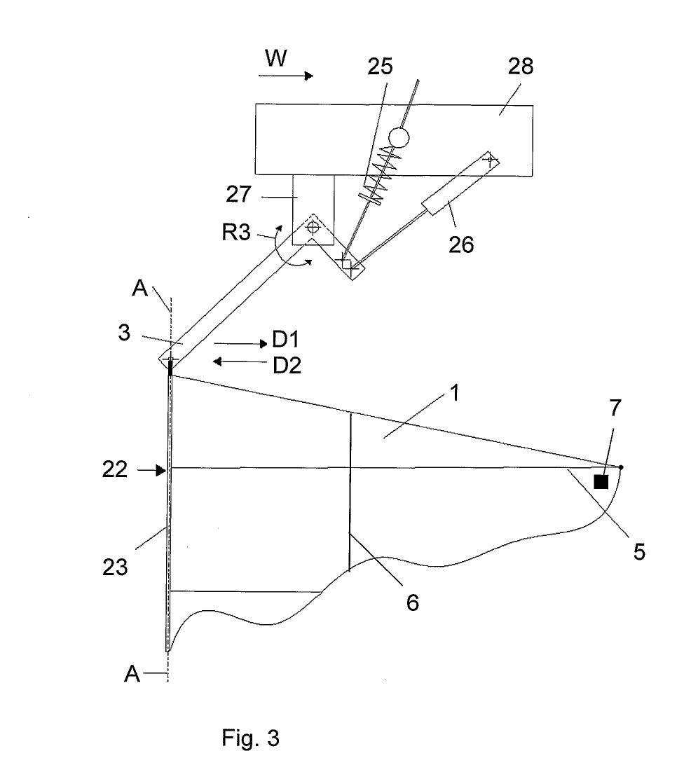

With reference to FIG. 3, the resilient member 25 has the form of a spring and is provided for bringing the sail 1 back against the wind by inducing a force on the first support 3 to which the sail 1 is connected. Thus, there is induced a movement of the sail 1 in the wind direction W, which is converted into useful work.

The first support 3 is L-shaped and is at its base connected to the previously mentioned further support, or third support 27, so that the first support 3 may rotate about an axle transverse to the wind direction W, which rotation is indicated as R3 in FIG. 3. The resilient member 25 is arranged in any suitable manner so that it induces a force on the first support 3 so as to move at least the part of the support 3 that is attached to the sail 1 in a direction opposite the wind direction W.

The movement of the first support 3 is rotational but a support that is linearly movable is also possible. The first support 3 should be movable at least in the second direction D2, not excluding any other directions of movement parallel with the surface of the sail 1 when the sail 1 is in its neutral position P1. In other words, the first support 3 moves in a first rotational direction and in a second rotational direction, as illustrated in FIG. 3.

The sail 1 is made of a material which preferably has anisotropic stiffness properties such that it is non-stiff around a horizontal axis and stiff around a vertical axis. This is to ensure that the sail 1 may rotate as described, but will prohibit wave propagation of the sail 1 in the horizontal direction. Any such waves will result in lower efficiency of converting the wind energy into useful work. Furthermore, it will assist in stretching out the sail 1. It is possible to achieve this stiffness property in the material by attaching one or several horizontal ribbons 5 to a non-stiff sail 1.

Preferably, a damped spring (not shown) is used for attaching sail 1 to at least one of the supporting structures 3, 4. The use of damped spring makes the tension of the sail 1 optimal and the oscillation of sail 1 more regular and robust.

Attached to the moveable supporting structure is also a hydraulic pump 26 for converting the movement into useful work, as later described. The hydraulic pump 26 may be replaced by a linear generator for producing electricity. Of course, a piston of the hydraulic pump 26 or the movable translator of the generator is connected to the first support for using the reciprocating movement for the purpose of producing energy.

The first support 3 and sail 1 should be attached to each other such that the sail 1 can rotate around the vertical axis.

Preferably the device also comprises means for limiting, breaking and stopping the movement of the first support 3 for securing smooth operations. Furthermore, it may include electronic equipment for converting alternating current to direct current.

In FIG. 1 the sail 1 has substantially a rectangular shape. Other shapes of sails 1 may also be used, such as triangular, oval, trapezoid, etc. As, mentioned, it can also be an advantage to use a sail 1 that has anisotropic density such that it has different area density at different points.

Higher density in a direction from the peripheral 22 edge towards a vertically opposite point of the sail 1 can be accomplished by attaching a weight 7 to the sail 1 at said opposite point. The weight 7 makes the oscillation of the sail 1 more regular and robust, and may reduce the frequency of oscillations. The mass of the sail 1 can also be tailored to the application so that a desired oscillation frequency is obtained. Instead of using a weight, a material which the sail is made of may be thicker at the rear 14 of the sail than at the front 13 of the sail.

It is also possible to arrange the second support 4 so as to move in the same manner as the first support 3, which means that the second support 4 would structurally correspond to the first support 3 but for being arranged in a mirror-inverted way. In this case the second support 4 is also connected to means for converting its movement into useful work, in a manner similar with the arrangement for the first support.

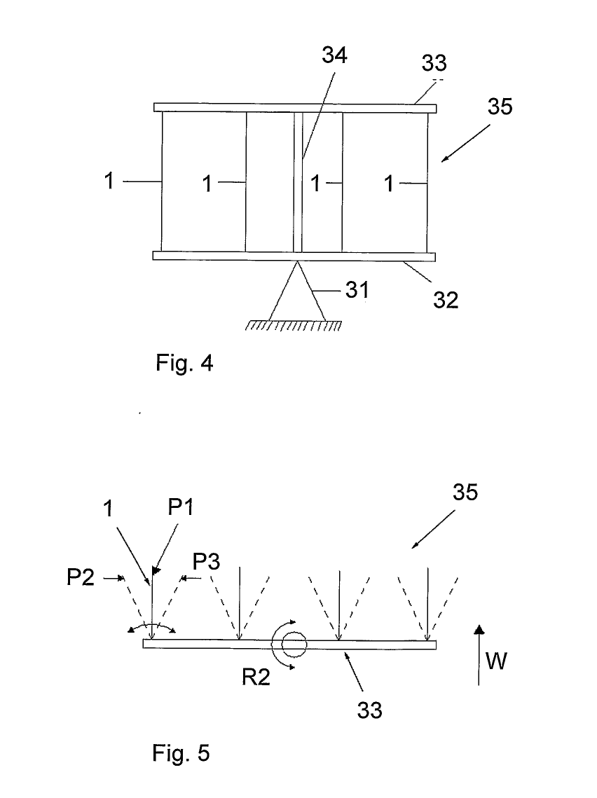

With reference to FIGS. 4 and 5, several sails 1 may be attached next to each other to form a large structure. A number of sails 1 are attached to a frame 35 that can be moved, or rotated as indicated by R2, around a base 31 to align it towards the wind. Every sail 1 is connected to the rotatable supporting structures at a an elongated top member 33 and elongated bottom member 32 of the frame 35. The top member 33 and bottom member 32 are parallel and spaced apart by a vertical frame member 34.

The sail 1 has been described as being arranged vertically, but other directions are possible, such as having an angle of 0 to 45 degrees in relation to the vertical. Also horizontal orientation would be possible. The axis around which the sail 1 oscillates or pivots may extend from the corners of a triangular sail 1. However, the supports 3, 4 may be arranged such that axis A is somewhat offset form the vertical. However, the axis A should be arranged so that the sail 1 will tend to return to the neutral position P1 and not rotate a complete circle. Thus, the structure 35 is rotated such that its top and bottom members 33, 32 extend in a direction transverse the wind direction W.

Rotation of the structure 35 in order to properly orient it against the wind direction W is done in any suitable manner.

If the axis A would be horizontal, a spring element may be arranged attached to a corner of the sail 1 at its attached to a support 3,4, which spring element maintains the sail 1 in a horizontal position parallel with the wind by exerting a force directed vertically upwards. Another spring element may be arranged to exert a force directed vertically downwards to assist in returning the sail 1 to the rest position.

The sail 1 can be made of fabric as described above. Alternatively, the sail 1 can be made of a more or less flexible material, such as a sheet of a plastics material or a sandwich construction. The sail 1 may have a larger stiffness in the horizontal direction compared to the stiffness in the vertical direction.

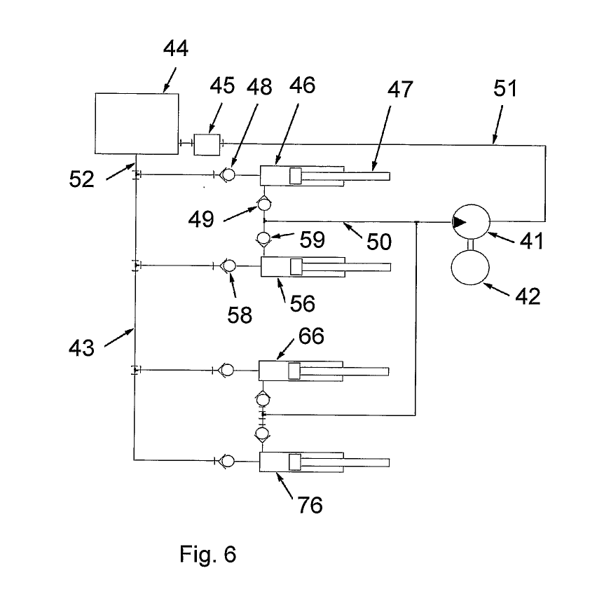

Turning now to FIG. 6, a wind energy system is described which comprises the structure 35 described above in connection with FIGS. 4 and 5. This system has four sails and four hydraulic pumps 46, 56, 66, 76 connected to a closed fluid line 43.

The hydraulic system consists of pipes 43, 51, 55 with low pressurized fluid and pipes 50 with high pressurized fluid. Four conventional hydraulic pumps 46, 56, 66 and 76 are connected to a respective movable sail-support via a respective piston that drives the fluid through the pipes. The piston of the first hydraulic pump is indicated by reference numeral 47. For each hydraulic pump there are two check valves that allow the fluid to flow in only one direction. The fluid drives a hydraulic engine 41, or hydraulic turbine, that is connected to a generator 42 for generating electricity. Furthermore, a tank 44 is used to store excessive fluid. When a piston 47 is pulled out of the housing of the hydraulic pump 46, fluid flows from the tank through the check valve in the low pressure part of the pipe system and into the pump. When the piston is forced into the pump the fluid in the pump is forced through the check valve into the high pressure pipes of the system. The fluid drives the hydraulic engine and returns to the tank. The piston may be connected directly or indirectly to the sail and resilient member according to FIG. 1 or FIG. 3 to drive the piston in and out of the pump.

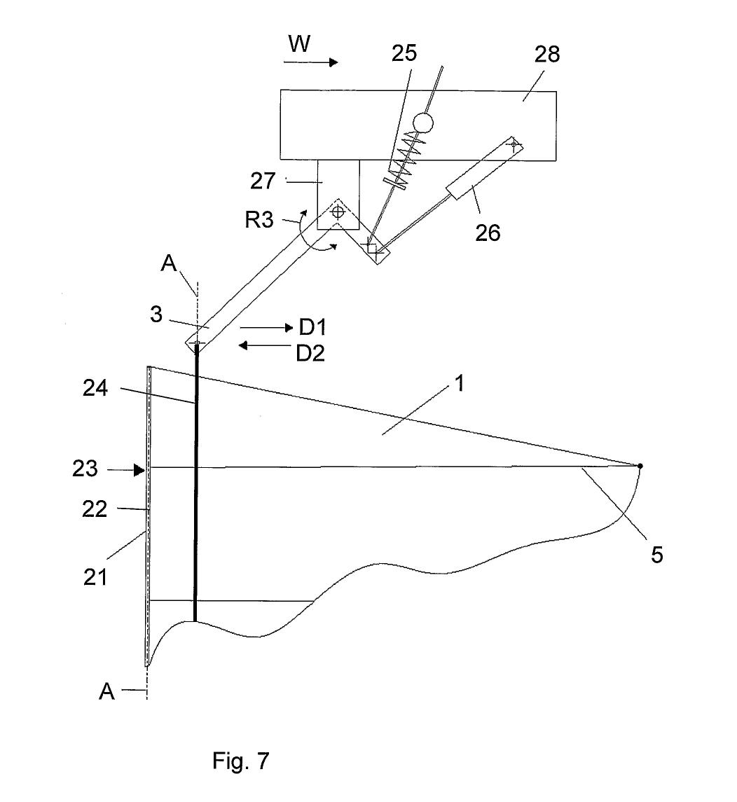

With reference to FIG. 7 an alternative configuration of the sail 1 is illustrated. Here the sail 1 is attached to the support 3 at a distance from the peripheral edge 22. Preferably, the sail 1 is also attached to the other support 4 at a distance from the peripheral edge 22. Between the supports a wire 24 is arranged in the sail 1 at the distance from the peripheral edge 22. This means that the previously mentioned axis A extends in the sail 1, or extends at least partly in the sail 1 in case one of the supports 3, 4 connects to the sail 1 at the edge 22 of the sail 2. From this it follows that the sail 1 extends on both sides of the geometrical axis, either in full or in part.

Generally, all terms used in the claims are to be interpreted according to their ordinary meaning in the technical field, unless explicitly defined otherwise herein. Hence all references to “a/an/the [element, device, component, means, step, etc]” are to be interpreted openly as referring to at least one instance of said element, device, component, means, step, etc., unless explicitly stated otherwise. The steps of any method disclosed herein do not have to be performed in the exact order disclosed, unless explicitly stated.

1. A device for converting wind energy into a reciprocating motion, said device comprising a sail connected to a first support and connected to a second support arranged at a distance from the first support, so that the sail is capable of pivotally oscillate about a geometrical axis extending between the supports, wherein the sail is configured to, when subjected to the wind, extend in a main wind direction, which defines a neutral position of the sail, and to pivotally oscillate about the axis and between two outermost positions at a respective side of the neutral position, and that the first support is configured to
move in a first direction when the sail during its oscillation moves towards any of its outermost positions from its neutral position, and
move in a second direction opposite the first direction when the sail during its oscillation moves towards its neutral position from any of its outermost positions,
for creating a reciprocating motion of the first support when the sail is subjected to the wind.

2. A device according to claim 1, further comprising a resilient member that biases the first support in the second direction.

3. A device according to claim 2, wherein the resilient member is configured such that, when the sail is subjected to a specific wind speed,
a force exerted by the resilient member on the first support in the second direction is smaller than a force exerted by the sail on the first support in the first direction when the sail is in any of its outermost positions,
a force exerted by the resilient member on the first support in the second direction is greater than a force exerted by the sail on the first support in the first direction when the sail is in its neutral position.

4. A device according to claim 1, wherein the sail has greater stiffness in a direction parallel with the main wind direction when the sail is subjected to wind, in comparison with the stiffness of the sail in the direction transverse the main wind direction.

5. A device according to claim 1, wherein the sail comprises ribbons extending in the main wind direction when the sail is subjected to wind.

6. A device according to claim 1, wherein the sail comprises ribbons extending in a direction from an upper part of the sail to a lower part of the sail.

7. A device according to claim 1, wherein the area density of the sail increases in a direction parallel with the main wind direction when the sail is subjected to wind.

8. A device according to claim 1, wherein the sail comprises a weight element.

9. A device according to claim 1, wherein the sail has a peripheral edge extending substantially along said geometrical axis.

10. A device according to claim 1, wherein the sail extends on both sides of the geometrical axis.

11. A device according to claim 1, wherein the movement of the sail between the outermost positions via the neutral position forms an arc.

12. A device according to claim 1, wherein the sail is configured such that, when the sail is in any of its outermost positions, the shape of the sail forms an arc bending in a direction away from the neutral position of the sail.

13. A device according to claim 1, wherein the sail is configured to oscillate freely between the two outermost positions.

14. A device according to claim 1, wherein the first support and the second support are connected to a third support that is rotatable about a substantially vertical axis.

15. A device according to claim 1, wherein each of the first support and the second support is rotatable about a substantially vertical axis.

16. A device according to claim 1, wherein the first support is configured such that first direction is substantially parallel with the main wind direction.

17. A device according to claim 1, further comprising a hydraulic pump connected to the first support, for converting the reciprocating motion of the first support to a flowing stream of fluid.

18. A wind energy system comprising at least two devices according to claim 17, the system further comprising a fluid line connected to each hydraulic pump and to a hydraulic engine, so that each stream of fluid flowing from the hydraulic pumps are transported to the hydraulic engine.

19. A wind energy system according to claim 18, wherein the fluid line is a closed system configured to return fluid from the hydraulic engine to each hydraulic pump.

20. A method of converting wind energy into a reciprocating motion, the method comprising
connecting a sail to a first support and to a second support arranged at a distance from the first support, such that the sail is capable of pivotally oscillate about a geometrical axis extending between the supports,
providing for the surface of the sail to extend, when subjected to the wind, in a main wind direction, which defines a neutral position of the sail,
allowing the sail to, when subjected to the wind, pivotally oscillate about the axis and between two outermost positions at a respective side of the neutral position, and
allowing the first support to move in a first direction when the sail during its oscillation moves towards any of its outermost positions from its neutral position, and move in a second direction opposite the first direction when the sail during its oscillation moves towards its neutral position from any of its outermost positions, for creating a reciprocating motion of the first support when the sail is subjected to the wind.
